(19) United States
(12) Patent Application Publication
(10) Pub. No.: US 2012/0005147 A1
(43) Pub. Date: Jan. 5, 2012

(54) INFORMATION LEAK FILE DETECTION APPARATUS AND METHOD AND PROGRAM THEREOF

(75) Inventors: HIROFUMI NAKAKOJI, Yokohama (JP); Tetsuro Kito, Yokohama (JP); Masato Terada, Kawasaki (JP); Shinichi Tankyo, Yokohama (JP); Isao Kaine, Kawagoe (JP); Tomohiro Shigemoto, Yokohama (JP)

(73) Assignee: Hitachi Information Systems, Ltd.

(21) Appl. No.: 13/170,943

(22) Filed: Jun. 28, 2011

(30) Foreign Application Priority Data
Jun. 30, 2010 (JP) 2010-148487

(51) Int. Cl. G06N 5/02

(52) U.S. Cl. 706/47

(57) ABSTRACT

A technique for collecting information concerning those files distributed on a file sharing network and for detecting an information leak file to take corrective measures is provided. Supervised information is generated by adding as attributes a file type, a speech-part appearance frequency of words making up a file name and a result of human-made judgment as to whether a file being inspected is the information leak file to key information collected from the file sharing network. Next, the supervised information is input to a decision tree leaning algorithm, thereby causing it to learn an information leak file judgment rule and then derive a decision tree for use in information leak file judgment. Thereafter, this decision tree is used to detect the information leak file from key information flowing on the file sharing network, followed by alert transmission and key information invalidation, thereby preventing damage expansion.

### INCORPORATION BY REFERENCE

This application claims priority based on a Japanese patent application, No. 2010-148487 filed on Jun. 30, 2010, the entire contents of which are incorporated herein by reference.

### BACKGROUND

The subject matter as disclosed in this description relates to an apparatus and method for detecting an information leak file being distributed via a file sharing network and for preventing expansion of damage, and also relates to a computer-executable software program for use therein.

Due to some causes including configuration setup errors of file sharing software and infection of a malware program (referred to as “malware” hereinafter), personal/private information and confidential corporate information flow out unintentionally onto a file sharing network, resulting in frequent occurrence of information leakage incidents.

In cases where information leakage is brought to light, it is desired to take remedial action rapidly. However, an information leakage incident which was caused by malware infection while nobody knows is such that time must often be taken until exposure of such incident. As a result, unwanted damage expansion can occur in many cases.

Currently known remedies for information leakage due to the file sharing software include a technique for making it difficult to download an information leak file by transmitting to a file sharing network an extra-large amount of spoofed files corresponding to the information leak file, which technique is disclosed in JP-A-2008-197854.

### SUMMARY

Generally, in order to discover the occurrence of an information leak, search is performed using a keyword(s) commonized to file names to be created by a malware. However, patterns in filenames are different per malware kind; so, the keyword(s) must be reset every time a new kind of malware appears.

Disclosed herein is a technique for detecting, without the aid of a specific keyword, a file which is suspected to be an information leak file from key information which are output by a device that collects information (key information) concerning those files being distributed on a file sharing network which is configured from file sharing software, thereby providing enhanced assistance for immediate management action to such information leakage incident.

An information leak file detection apparatus as disclosed herein is an apparatus which detects an information leak file(s) being distributed on a file sharing network, characterized in that the detection apparatus acquires key information-constituting items from key information collected from one or a plurality of key collection devices (crawlers) along with properties that are derived from the items, and generates by using a decision tree learning algorithm a decision tree for use in judgment of an information leak file from both these information and a result of decision-tree manager's judgment as to whether a file being inspected is the information leak file based on these information. A further feature of the apparatus lies in that this decision tree is used to classify or categorize the key information to be acquired from the key collection device to thereby detect the information leak file.

By generating a decision tree which does not involve the processing for comparison with a fixed keyword in the way using the above-stated features, it becomes possible to achieve versatile information leak file detection which does not depend on the kind of malwares.

With the technique disclosed herein, it becomes possible to cope rapidly with information leakage caused by a new malware.

These and other benefits are described throughout the present specification. A further understanding of the nature and advantages of the invention may be realized by reference to the remaining portions of the specification and the attached drawings.

### BRIEF DESCRIPTION OF DRAWINGS

FIG. 1 shows one exemplary configuration of an information leak file detection system.

FIG. 2 shows one example of an analysis information database (DB), wherein part (a) of it shows one example of key information stored in a learned information DB, and part (b) shows attribute information stored in the learned information DB.

FIG. 3 shows flowcharts, wherein part (a) is for explanation of a comparative example of the processing for detecting an information leak file whereas part (b) is for explanation of an overview of one embodiment of the information leak file detection processing.

FIG. 4 shows tables, wherein part (a) shows one example of a time-and-date expression pattern and part (b) shows one example of correlation of a file name (extension) and file type.

FIG. 5 shows one example of a scheme for deriving attributes of parts of speech from a file name in an attribute addition program.

FIG. 6 shows one example of a scheme for deriving a decision tree and judgment-use program code from supervised information in a key learning program.

FIG. 7 shows one example of a configuration of information leak file detection apparatus.

FIG. 8 shows one example of a learned information DB.

FIG. 9 shows a flow of processing in the attribute addition program.

FIG. 10 shows a flow of processing in the key learning program.

FIG. 11 shows a processing flow in a key analysis program.

FIG. 12 shows one example of the information leak file detection system of this embodiment.

### DESCRIPTION OF THE EMBODIMENTS

A currently preferred form for implementation of this invention (referred to hereinafter as “embodiment”) will be described in greater detail while referring to figures of the drawing where necessary.

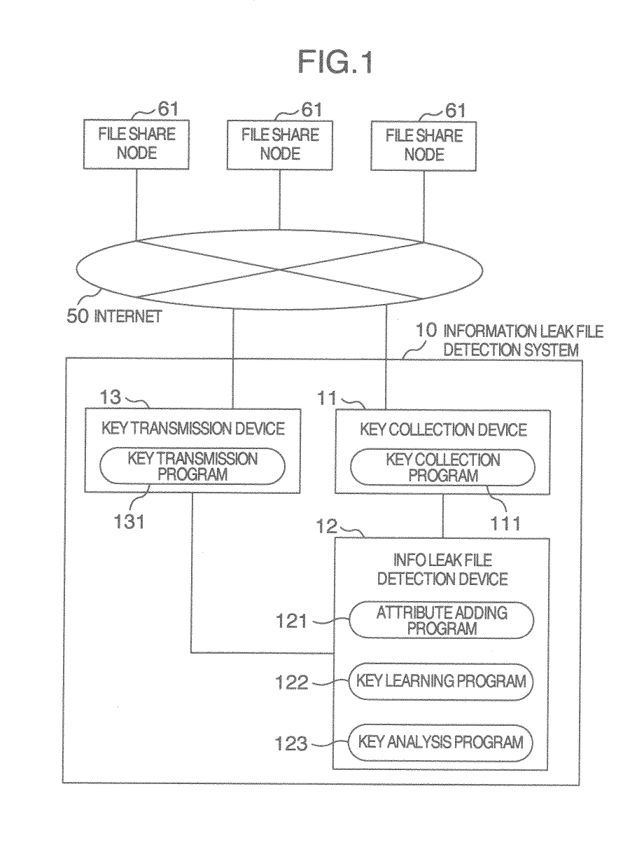

First of all, an explanation will be given, using FIG. 1, of a configuration example of an information leak file detection system which learns features of an information leak file flowing on a file sharing network and detects an information leak file(s) with similarity thereto. FIG. 1 is a diagram showing one configuration example of the information leak file detection system.

In FIG. 1, the information leak file detection system 10 is configured including a key collection device 11, an information leak file detection device 12 and a key transmission device 13. It is noted that another configuration having a plurality of key collection devices 11, information leak file detection devices 12 and key transmission devices 13 is also employable although a single one is illustrated for each device in FIG. 1

The key collection device 11 is coupled to the Internet 50, for collecting key information being distributed on the file sharing network by acquiring key information concerning a shared file(s) while being connected to respective ones of a plurality of file share nods 61 that are linked to the Internet 50.

The key transmission device 13 joins up with the Internet 50 for providing connection to respective ones of the plurality of file share nodes 61 being linked to the Internet 50 and for transmitting thereto any given key information to thereby obstruct distribution of the key information of an information leak file to the file sharing network.

The information leak file detection device 12 collects one or a plurality of pieces of key information held by the key collection device 11 and then applies processing (attribute addition) thereto by an attribute adding program 121. Next, the information are manually categorized (classified) into key information of the information leak file and key information of other normal files. Then, a key learning program 122 is rendered operative to read the resulting information (key information, attributes and classes) as supervised information to thereby generate a decision tree for use in judgment of the information leak file. The decision tree generated is set to an information leak file judgment rule(s) of a key analysis program 123 whereby information leak file judgment is carried out; then, information concerning the information leak file is passed to the key transmission device 13. A detailed description of the processing of this information leak file detection device 12 will be given later.

Note that in FIG. 1, solid lines tying respective blocks (11-13) indicate transmission paths of communication data packets relating to the key information.

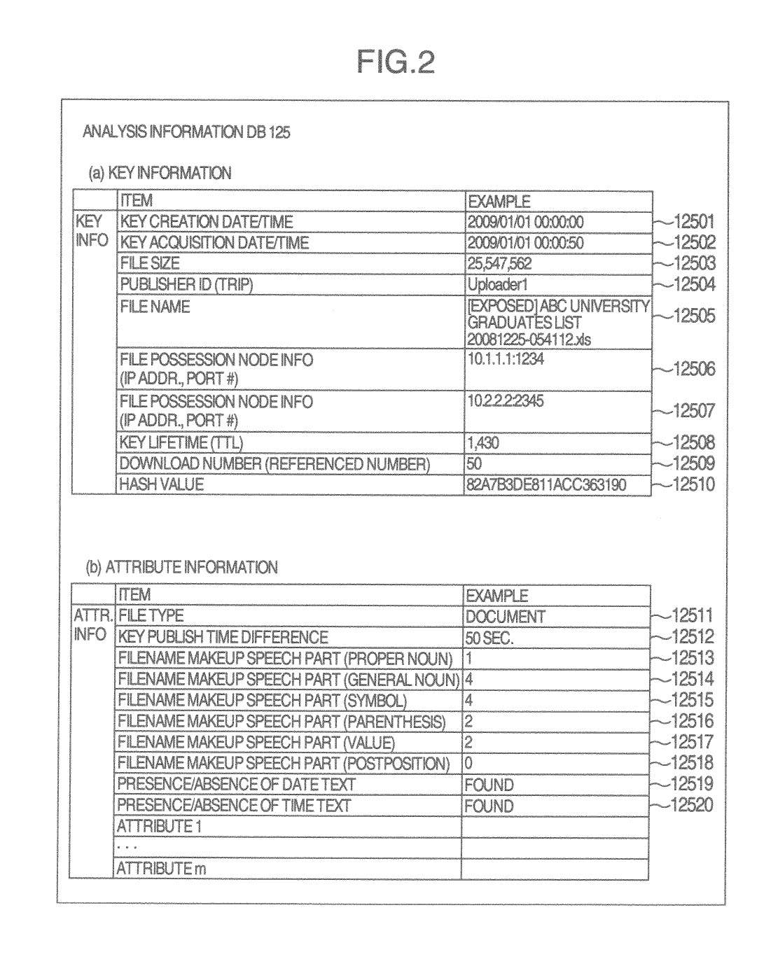

An explanation will now be given of one example of the key information with reference to part (a) of FIG. 2. The part (a) of FIG. 2 shows one example of the key information of Winny, which is a Japanese peer-to-peer (P2P) file-sharing software program. In the Winny, major data to be recorded as the key information are as follows: a key creation time-and-date 12501, key acquisition time-and-date 12502, file size 12503, publisher ID (trip) 12504, file name 12505, file possession node information (IP address, port number) 12506, key possession node information (IP address, port number) 12507, key lifetime (time to live or “TTL”) 12508, download number (referenced number) 12509 and hash value 12510.

The key creation time-and-date 12501 is a time point at which the key information was generated, which represents either when the file was shared or when the key information was updated. The key acquisition time-and-date 12502 indicates when the key collection device 11 acquired the key information. The publisher ID (trip) 12504 is the information for uniquely identifying an owner of the file. The file possession node information (IP address, port number) 12506 is a combination of Internet Protocol address and port number of a node which presently owns the file, and indicates node information stored in the key information. The key possession node information (IP address, port number) 12507 is a combination of IP address and port number of a key information-owning node: this information indicates the IP address and port number which have been used when an online interconnection was established to acquire the key information. The key lifetime (TTL) 12508 is a value which indicates, in seconds (sec.), a remaining length of time up to automatic extinction or “run-out” of the key information. The download number (referenced number) 12509 is a value indicating, in megabytes (MB), a cumulative total size which was downloaded based on this key information. The hash value 12510 is an identifier for uniquely identifying the file; precisely, it is the information calculated using a hash function, such as MD5, SHA-1 or the like. Note here that the node information indicated by the file possession node information (IP address, port number) 12506 does not exclusively indicate the file possession node and, in some cases, stores an IP address and port number which have been rewritten by another node.

Although illustration is omitted of configurations of the key collection device 11 and key transmitter device 13, each device includes an arithmetic operational unit for controlling various kinds of arithmetic processing operations and transmission and reception of key information by means of an application program(s), an input unit for entry of information, a display unit for visually displaying on its screen arithmetic processing results and instructions, a communication unit for control of two-way communication with other devices, and a storage unit for storing application programs and arithmetic computation results. Additionally, a detailed explanation as to the configuration of the information leak file detection device 12 will be given later.

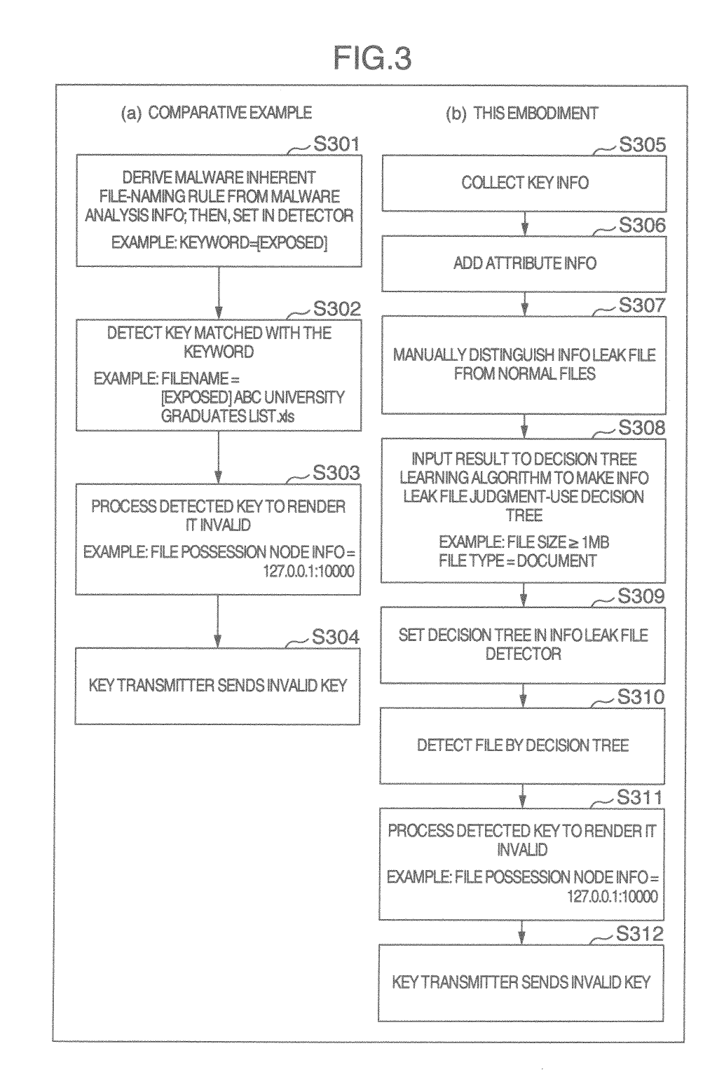

This embodiment will be set forth in detail using FIG. 3. Part (a) of FIG. 3 is a diagram for explanation of a comparative example of one prior art information leak file detection processing whereas part (b) is a diagram for explanation of this embodiment.

The comparative example shown in part (a) of FIG. 3 is in the case where an information leak file is processed by the prior art technique (keyword matching method) based on the naming rule of a malware (FIG. 1 is also referred to when needed).

Firstly, a human operator investigates the malware's naming rule by analyzing the malware and/or by taking into consideration the laid-open information of a malware info-service web site or else. In this case, when two or more kinds of malwares are present or when two or more naming rules exist for a single malware, an attempt is made to extract a plurality of keywords (at step S301). Next, the file name of the key information gained from the key collection device 11 is compared to the extracted keyword to thereby determine whether the key information is an information leak file or not (step S302). Further, when the key information is judged to be the information leak file, the file possession node that is a constituent element of the key information is subjected to the processing of rewriting it into an IP address which is different from the original IP address, thereby rendering the key information invalid (S303). Finally, this key information is passed to the key transmitter device 13; then, the key information is sent out toward the file sharing network (S304).

Next, an explanation will be given of a processing flow of this embodiment shown in part (b) of FIG. 3 (also referring to FIG. 1 when needed).

First, a constant number of key information are acquired from the key collection device 11 (at step S305). Then, attribute information, such as a file type or else, is added to the key information acquired (step S306). Next, the operator judges from each key information whether it is the key information concerning the information leak file or the key information as to a normal file other than the information leak file, thereby generating supervised information with a decision result being added to the individual key information (S307). This supervised information is input to a decision tree learning algorithm to thereby generate a decision tree for judgment of the information leak file (S308). This decision tree is set up in the information leak file detection device 12 (S309). Thereafter, the information leak file detection device 12 uses this decision tree to classify the key information collected by the key collection device 11 and then judges the information leak file (S310). Further, in a case where the key information is determined to be relevant to the information leak file, the key information is rendered invalid by the processing for rewriting the IP address of the file possession node which is a constituent element of the key information (S311). Lastly, this key information is passed to the key transmission device 13, which sends out the key information to the file sharing network (S312).

That is to say, in this embodiment, information leak file detection which does not rely upon keywords, i.e., does not depend on malware kinds, is realized by first learning the human-judged criteria based on the key information actually collected by the key collection device 11 and then using such criteria in information leak file judgment to be later performed.

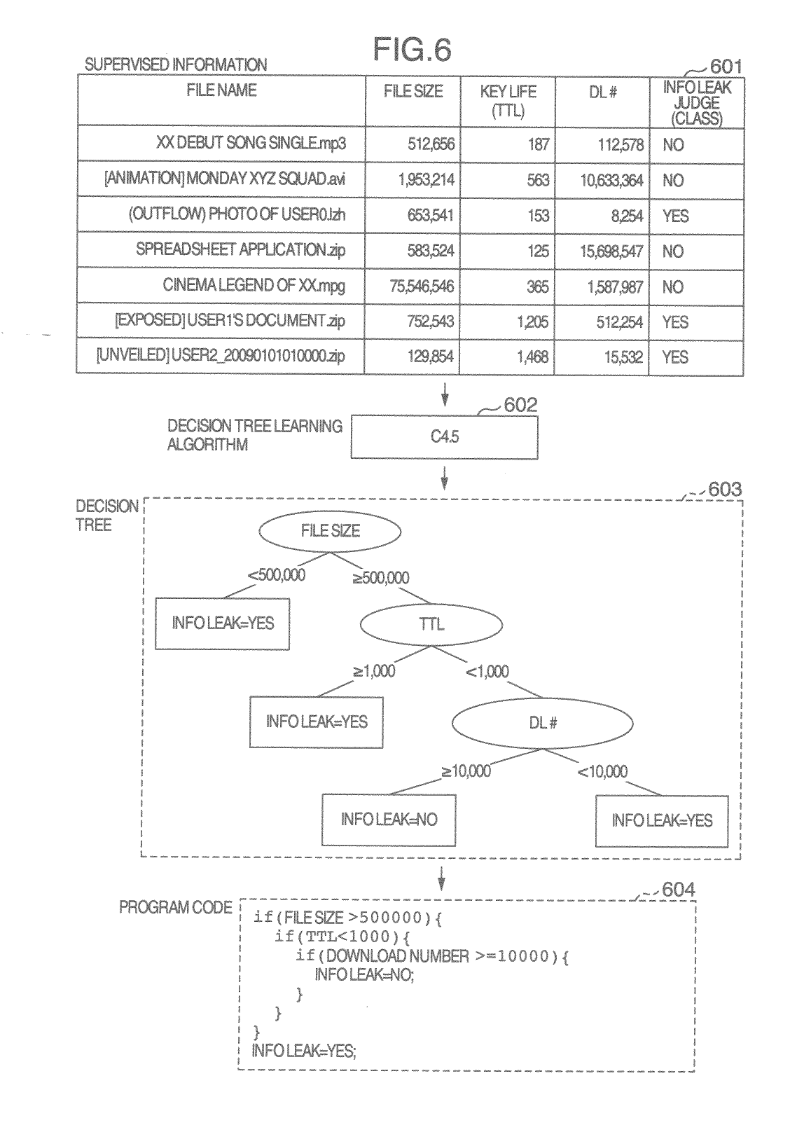

Next, the generation of a decision tree will be explained using FIG. 6 while taking the key information of Winny as an example.

FIG. 6 shows an example which derives a decision tree 603 after having input a piece of prepared supervised information 601 into a decision tree learning algorithm 602 for generation of the decision tree 603. The supervised information 601 consists essentially of key information and an information leakage judgment result (class) which is obtained by the operator's judgment as to whether it is the information leak file or not based on constituent elements of the key information, including the file name and others. Although in FIG. 6 only the key information and the class are shown for purposes of brevity of illustration and discussion herein, the supervised information is designable to contain additional attribute information other than these key information and class, which are to be derived from the key information. Details of the attribute information will be described later.

In FIG. 6, there is shown the case of a decision tree being generated using a generally known algorithm “C4.5” as the decision tree learning algorithm 602. By using C4.5, a decision tree 603 is generated which indicates the relationship of a value of each item of the supervised information 601 and a class. The class as used herein is a parameter which is able to have one of two kinds of values indicating whether a file being inspected is the information leak file (“Yes”) or not (“No”).

Although in FIG. 6 the class having one of two kinds of values is shown as an example for purposes of brevity of explanation, it is also possible by preparing supervised information with a multi-valued class to generate another version of decision tree 603 made up of a class having multiple values. An example is that the class indicative of a file category arrangeable to have any one of four kinds of values corresponding to a malware-caused information leak file, human-induced information leak file, normal file and copyrighted material file, respectively. The malware-caused information leak file refers to a file which was leaked after having been renamed by a computer malware without permission. The human-induced information leak file is a file that was leaked either by intent or by setup error, rather than caused by malwares. The copyrighted material file is a file in which copyright-protected contents are included.

It is noted that the algorithm C4.5 is merely one example of the decision tree learning algorithm 602, and other algorithms may alternatively be used therefor.

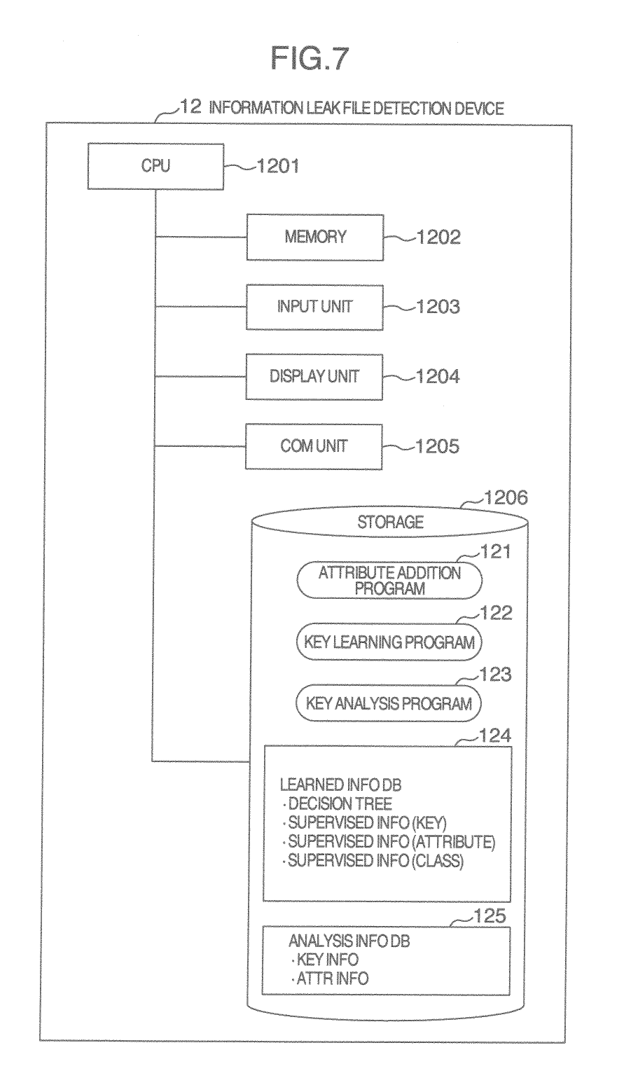

Next, an explanation will be given of a configuration of the information leak file detection device 12 with reference to FIG. 7, FIG. 7 is a diagram showing one example of the configuration of the information leak file detection device.

The information leak file detection device 12 is realizable on a computer including an arithmetic operational unit 1201, memory 1202, input unit 1203, display unit 1204, communication unit 1205 and storage unit 1206.

The arithmetic unit 1201 controls respective components (1202 to 1206) of the information leak file detection device 12 and also controls data transmission between any two of respective components (1202-1206). An example of the arithmetic unit 1201 is a central processing unit (CPU) which executes arithmetic processing tasks. This CPU loads into the memory 1202 that is a main storage device an application program to be later described and then executes it, thereby realizing the processing to be explained below. The memory 1202 may typically be a random access memory (RAM) module. It is noted that the application program is stored in the storage unit 1206, such as a hard disk drive (HDD) unit.

Also note that an explanation to be given below assumes that each computer program is an execution principal for purposes of convenience of discussion herein.

Each program may be prestored in the storage unit 1206 or, alternatively, may be installed, when the need arises, in the storage unit 1206 from another device via an external interface (not illustrated) and the communication unit 1205 as well as a media usable by the information leak file detection device 12. Examples of the media include a removable storage medium attachable to the external interface and a communication medium (i.e., a wired, wireless or optical network; a carrier wave or digital signal to be transferred on the network).

The input unit 1203 may typically be a keyboard with or without a pointing device called the mouse, for permitting entry of information or data by an operator or like person who manually operates the information leak file detection device 12.

The display unit 1204 may be a cathode ray tube (CRT) or liquid crystal display (LCD) monitor, which displays an on-screen image for prompting data input and an image or “window” for ascertainment of computation results.

The communication unit 1205 functions to transmission and reception of data between each part (11, 13) within the information leak file detection system 10 (see FIG. 1) and one or a plurality of file-sharing nodes 61 being presently linked to the Internet 50.

The storage unit 1206 stores therein the attribute addition program 121, the key learning program 122, the key analysis program 123, a learned information database (DB) 124 and an analysis information DB 125. Additionally, any one of the attribute addition program 121, key learning program 122 and key analysis program 123 is loaded into the memory 1202 as an application program and is then executed by the arithmetic unit 1201.

The attribute addition program 121 operates to add attribute information to the key information collected. The attribute information means pertinent or relevant information to be derived from individual items which constitute the key information. The key information that becomes a reference source is stored in the analysis information DB 125 as the key information and stored in the learned information DB 124 as the supervised information (key information), respectively. Further, the attribute information added is saved in the analysis information DB 125 as the attribute information and in the learned information DB 124 as the supervised information (attribute), respectively.

The key learning program 122 uses the decision tree learning algorithm 602 to output, as the decision tree 603, rules of the supervised information (attribute) and supervised information (class) for causing the supervised information (class) to become a conclusion from the supervised information (key information) and supervised information (attribute) plus supervised information (class) which are stored in the learned information DB 124. Note here that the supervised information (class) is a value which indicates the conclusion as to whether a file being inspected is the information leak file or not. The key learning program 122 stores the outputted decision tree 603 in the learned information DB 124.

The key analysis program 123 performs classification of key information by using the key information and attribute information stored in the analysis information DB 125 and the decision tree 603 saved in the learned information DB 124. Note here that the classification denotes a process of deriving a conclusion by processing the key information and attribute information stored in the analysis information DB 125 in accordance with the rule(s) indicated by the decision tree 603 saved in the learned information DB 124. More specifically, in this example, a choice between only two alternatives is made to determine whether a file under inspection is the information leak file.

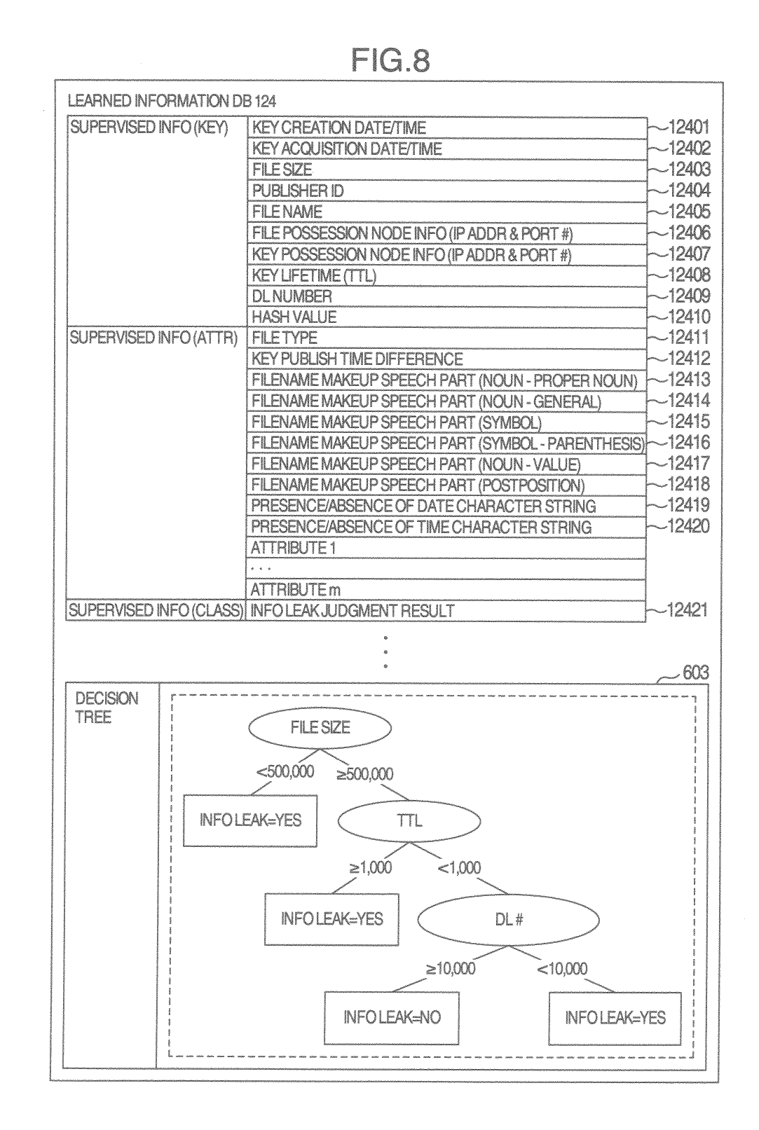

Next, an explanation will be given of the learned information DB 124 with reference to FIG. 8. FIG. 8 is a diagram showing one example of the learned information DB.

The learned information DB 124 includes the decision tree 603 and further includes per key information the supervised information (key information), supervised information (attribute) and supervised information (class). The supervised information (key information) is the information as to those files flowing on the file sharing network, which information is acquired from the key collection device 11 (see FIG. 1). Additionally, the supervised information (attribute) is the information obtained by the processing of an item or items of either the supervised information (key information) or the key information stored in the analysis information DB 125.

The supervised information (key information) is a reference or a duplicate copy of the key information saved in the analysis information DB 125: the contents are the same. In the key information, there are several items which follow.

A key creation time-and-date 12401 is the one that specifies when the key information is generated: it indicates either when the file was shared or when the key information was updated.

A key acquisition time-and-date 12402 indicates when the key collection device 11 acquired the key information.

A publisher ID (trip) 12403 is the information for uniquely identifying an owner of the file.

A file possession node information (IP address, port number) 12406 is a pair of IP address and port number of a node which presently owns the file, and indicates node information stored in the key information.

A key possession node information (IP address, port number) 12407 is a pair of IP address and port number of a node which presently owns key information, and indicates the IP address and port number which have been used when the key collection device 11 established a connection for acquisition of the key information.

A key lifetime (time-to-live or “TTL”) 12408 is a value indicating, by seconds, a remaining time length up to automatic extinction of the key information.

A download number (referenced number) 12409 is a value representing, by megabytes (MB), a cumulative total size which was downloaded based on this key information.

A hash value 12410 is an identifier for unique identification of a file, which is the information that was computed using a hash function, such as MD5. SHA-1 or else.

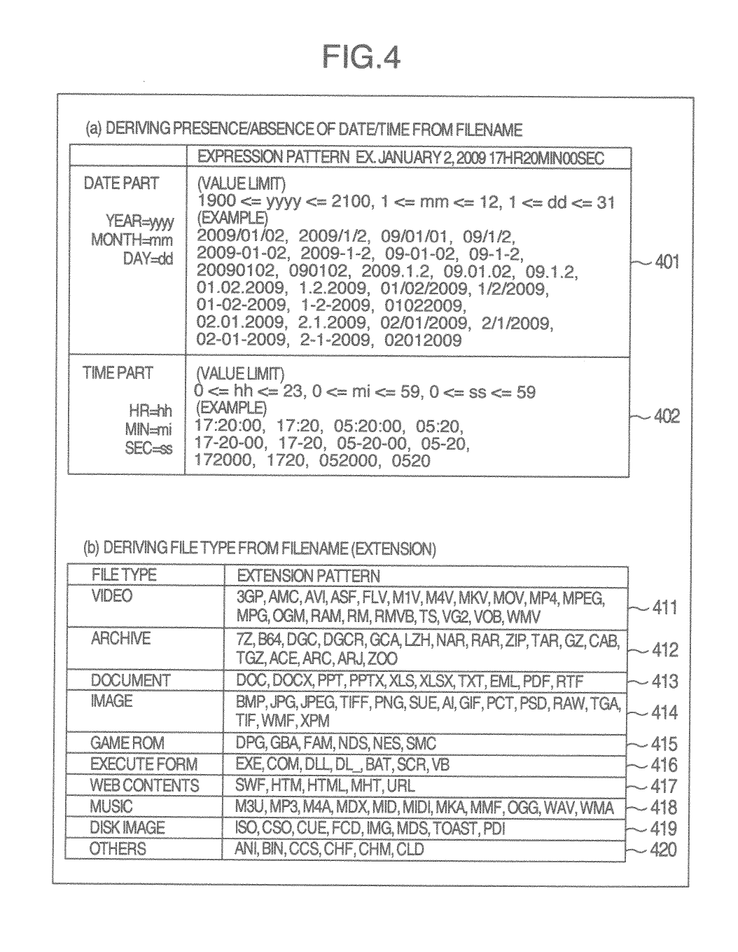

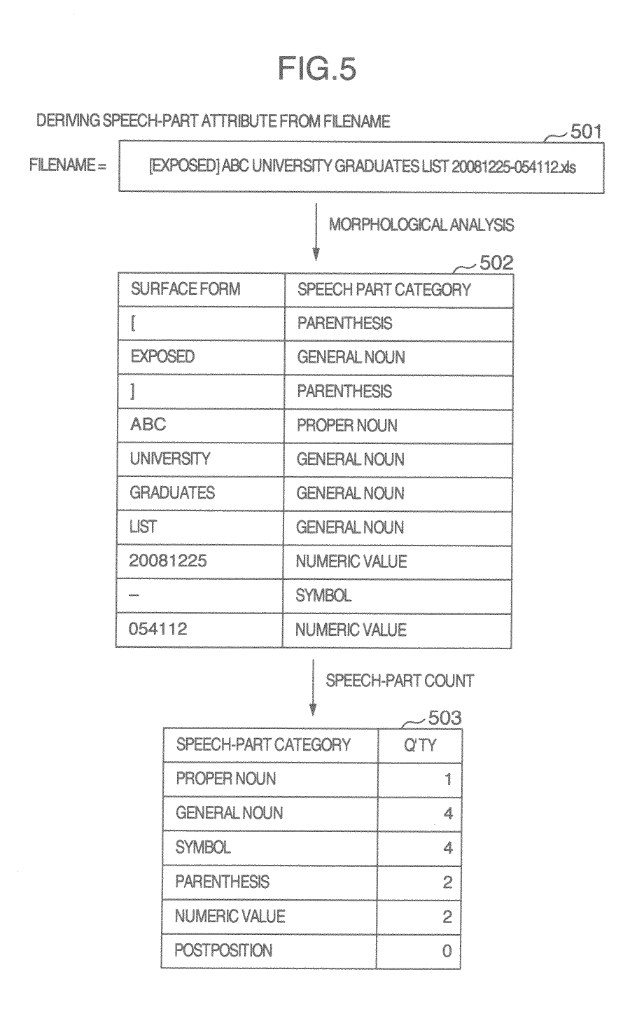

Next, an explanation will be given of those items to be stored in the supervised information (attribute) by using FIGS. 4 and 5. The supervised information (attribute) is a reference or a copy of the attribute information stored in the analysis information DB 125: the contents are the same.

A key publication time difference 12412 shown in FIG. 8 is a value indicating, by seconds, a time difference between the key creation time-and-date and key acquisition time-and-date which are recorded in the key information.

A file type 12411 is any one of file types which are classified using a table shown at part (b) of FIG. 4 based on a file extension that is included in the file name of the key information, wherein the types are video, archive, document, image, game ROM, executable program, web contents, music (audio), disk image and others. The table is one example and is not to be construed as limiting the invention.

An item 12419 specifying the presence or absence of a date character string and an item 12420 specifying the presence/absence of a time point character string indicate a result of judgment as to whether any one of a date inscription pattern 401 and a time inscription pattern 402 shown at part (a) of FIG. 4 is included in the file name 12405 of the key information.

As for a filename makeup speech part (proper noun) 12413, filename makeup speech part (general noun) 12414, filename makeup speech part (symbol) 12415, filename makeup speech part (parenthesis) 12416, filename makeup speech part (numerical value) 12417 and filename makeup speech part (postposition) 12418, each is obtainable by disassembling either a file name or a character string 501 with an extension excluded from the file name into words 502 as shown at part (a) of FIG. 5 and then counting an appearance number 503 of every speech part of such words on a per-speech part basis. As one example of such disassembly or “resolving” of the file name character string into words, there is a method which uses morphological analysis. Additionally, examples of the part of speech include the above-stated proper noun, general noun, symbol, numeric value and postposition. The morphologic analysis method and the kinds of speech part are mere examples and are not to be construed as limiting the invention.

Suppose that the attribute information is extensible to have additional ones (attributes “1” to “m”) as shown at part (b) of FIG. 2.

Next, an explanation will be given of the supervised information (class). The supervised information (class) is the information indicating a result of judgment of the individual key information, and is a conclusion which expects the information leak file detection device 12 to derive it as a detection result thereof. In this example, it may have two kinds of values, one of which indicates an information leak file and the other of which indicates a normal file (i.e., a file which is not the information leak file). The supervised information (class) is such that its value is set up by the operator's judgment of the supervised information (key information) and supervised information (attribute) which are stored in the learned information DB 124.

Next, the analysis information DB 125 will be explained using FIG. 2.

The analysis information DB 125 includes key information and attribute information. Individual items constituting the key information and attribute information are the same as those of the supervised information (key information) and supervised information (attribute) of the learned information DB 124 stated supra.

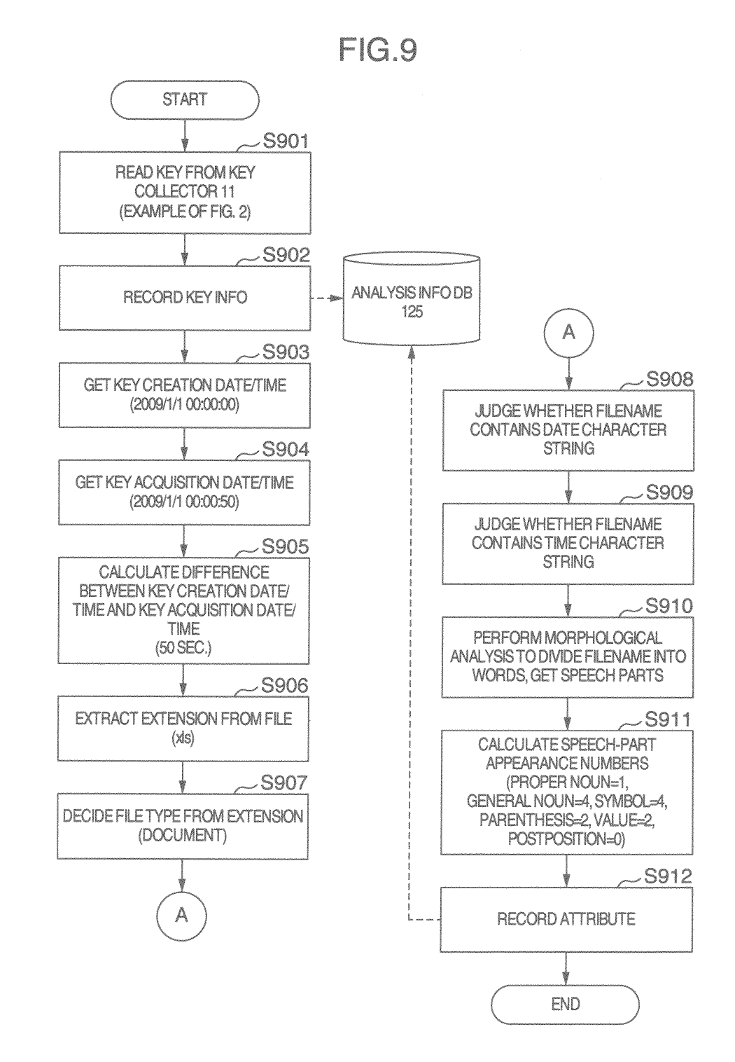

Here, a flow of processing in the attribute addition program 121 and an attribute information example will be explained using FIG. 9 and part (b) of FIG. 2. FIG. 9 is a diagram showing a flow of the processing in the attribute addition program Part (b) of FIG. 2 is a diagram showing one example of the attribute information.

As shown in FIG. 9, when the attribute addition program 121 (see FIG. 7) is rendered operative, it reads the key information from the key collection device 11 (at step S901). Here, key information containing therein the contents shown in FIG. 2 (i.e., key information with the file name 12505 being set to “[Exposed] ABC university graduates list 20081225-054112.xls”) is read out.

Respective items making up the key information thus read are recorded as key information in the analysis information DB 125 (at step S902).

From the key information, the key creation time-and-date 12501 is acquired. Here, “2009/1/1 00:00:00” is obtained as the key creation time-and-date 12501 (see FIG. 2) (step S903).

In addition, the key acquisition time-and-date 12502 is acquired from the key information. Here, “2009/1/1 00:00:50” is gained as the key acquisition time-and-date 12502 (see FIG. 2) (step S904).

A value of the resultant key acquisition time-and-date 12502 minus the key creation time-and-date 12501 (i.e., key laid-open time difference) is calculated. Here, this value is set to 50 seconds although the unit is not limited to seconds (step S905).

Next, from the file name 12505 (“[Exposed] ABC university graduates list 20081225-054112.xls”), its extension “xls” is extracted (step S906).

Then, a file type is judged from a correspondence table of extensions and file types (see part (b) of FIG. 4). Here, a judgment result of “document” 413 is obtained (step S907).

Subsequently, processing is performed to determine whether the date pattern 401 representable at part (a) of FIG. 4 is contained in the file name 12505 (“[Exposed] ABC university graduates list 20081225-054112.xls”) Here, a character string “20081225” which coincides with the date representation pattern is included in the file name; so, it is judged that the date character string is included therein (step S908).

Further, processing is done to determine whether the time pattern 402 representable at part (a) of FIG. 4 is contained in the file name 12505 (“[Exposed] ABC university graduates list 20081225-054112.xls”). Here, a character string “045112” which matches the time expression pattern is included in the file name; so, it is judged that the time character string is included (step S909).

Next, the file name 12505 (“[Exposed] ABC university graduates list 20081225-054112 xls”) is disassembled or “resolved” into words by the morphological analysis scheme shown in FIG. 5; thus, speech parts of the individual word are obtained (step S910). An engine which executes the morphological analysis may be designed using currently available tools and/or libraries for installation therein. Here, as a result of such analysis, the following result is obtained: “[” is a parenthesis; “Exposed” is a general noun; “]” is a parenthesis; “ABC” is a proper noun; “university” is a general noun; “graduates” is a general noun; “list” is a general noun; “20081225” is a numerical value; “-” a symbol; and, “054112” is a numeric value.

Based on the result obtained by the morphological analysis, an appearance number of each part of speech is counted up (step S911). Here, the proper noun, general noun, symbol, parenthesis, numeric value and postposition are selected as the objects to be counted. As a result, the following is obtained: the filename makeup speech part (proper noun) 12513 is 1 (=1), filename makeup speech part (general noun) 12514=4, filename makeup speech part (symbol) 12515=4, filename makeup speech part (parenthesis) 12516=2, filename makeup speech part (value) 12517=2, and filename makeup speech part (postposition) 12518=0. Note that other speech parts, such as verb and countable noun or the like, may be chosen as the objects to be counted. Further note that a filename makeup speech part number may be newly generated and selected which is a result of arithmetic processing (e.g., addition) of the appearance number of the filename makeup speech part (proper noun) 12513 and the appearance number of filename makeup speech part (general noun) 12514.

Finally, the results obtained by the above-stated processing operations, i.e., key publication time difference 12512=50 seconds, file type 12511=document, presence/absence of date character string 12519=present, time character string presence/absence=present, filename makeup speech part (proper noun) 12513=1, filename makeup speech part (general noun) 12514=4, filename makeup speech part (symbol) 12515=4, filename makeup speech part (parenthesis) 12516=2, filename makeup speech part (numeric value) 12517=2 and filename makeup speech part (postposition) 12518=0, are recorded in the analysis information DB 125 (step S912).

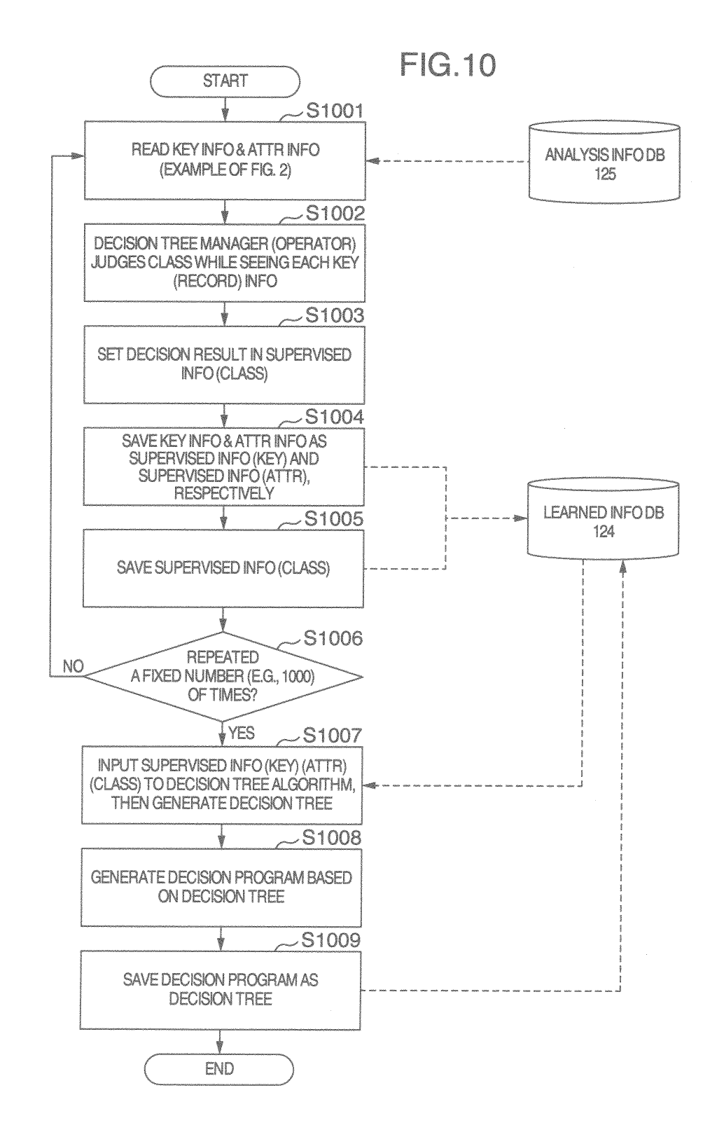

Next, a flow of processing in the key learning program 122 and an example of the decision tree will be set forth using FIG. 10 and FIG. 6. FIG. 10 is a diagram showing a processing flow in the key learning program. FIG. 6 is a diagram showing examples of the decision tree and supervised information.

Firstly, the key learning program 122 reads from the analysis information DB 125 a pair of key information and attribute information (at step S1001). Here, suppose that the uppermost record of the supervised information 601 shown in FIG. 6 (i.e., the key information with a file name of “XX debut song single.mp3”) is read.

Next, the key information and attribute information thus read are browsed by the operator. Then, he or she judges whether this information is the information pertinent to the information leak file (step S1002). Here, the operator can judge that the file name “XX debut song single.mp3” is not relevant to the information leak file; so, the operator judges that it is not the information leak file.

A judgment result of the step S1002 (i.e., information leak file=No) is set in the supervised information (class) (step S1003).

Then, the key information and attribute information that are read at the step S1001 are recorded in the learned information DB 124 as the supervised information (key information) and supervised information (attribute), respectively (step S1004).

Further, the supervised information (class) that was set up at the step S1003 is recorded in the learned information DB 124 (step S1005). A set of these supervised information (key information) and supervised information (attribute) plus supervised information (class) becomes supervised information corresponding to one key information.

Next, the read-in number of the key information is compared to a preset learning number, thereby determining whether the key information read number is greater than the learning number (step S1006). Here, assume that the learning number is 1000. Since the read number of key information at this stage is 1, the procedure returns to the step S1001, for further generation of supervised information.

From here, the routine of from the steps S1001 up to S1006 is executed repeatedly. When it is decided at step S1006 that a prespecified number is reached, the procedure goes to the next processing. More specifically, this means that the supervised information have been generated from a thousand of pieces of key information at this stage.

The supervised information 601 stored in the learned information DB 124 are input to the decision tree learning algorithm 602 to thereby obtain a decision tree 603 (at step S1007). Here, as shown in FIG. 6, C4.5 is used as the decision tree learning algorithm to obtain a rule(s) shown in FIG. 6 as the decision tree 603. Note that the type of the decision tree learning algorithm and those parameters to be given to the algorithm are not to be construed as limiting the invention.

Based on the decision tree 603 obtained at step S1007, a judgment program 604 which is executable is generated by the key learning program 122 (step S1008). Here, from the decision tree 603 shown in FIG. 6, a judgment-use program code 604 having built-in conditional branching is generated.

Lastly, the judgment-use program code 604 is recorded in the learned information DB 124 as the decision tree 603 (step S1009).

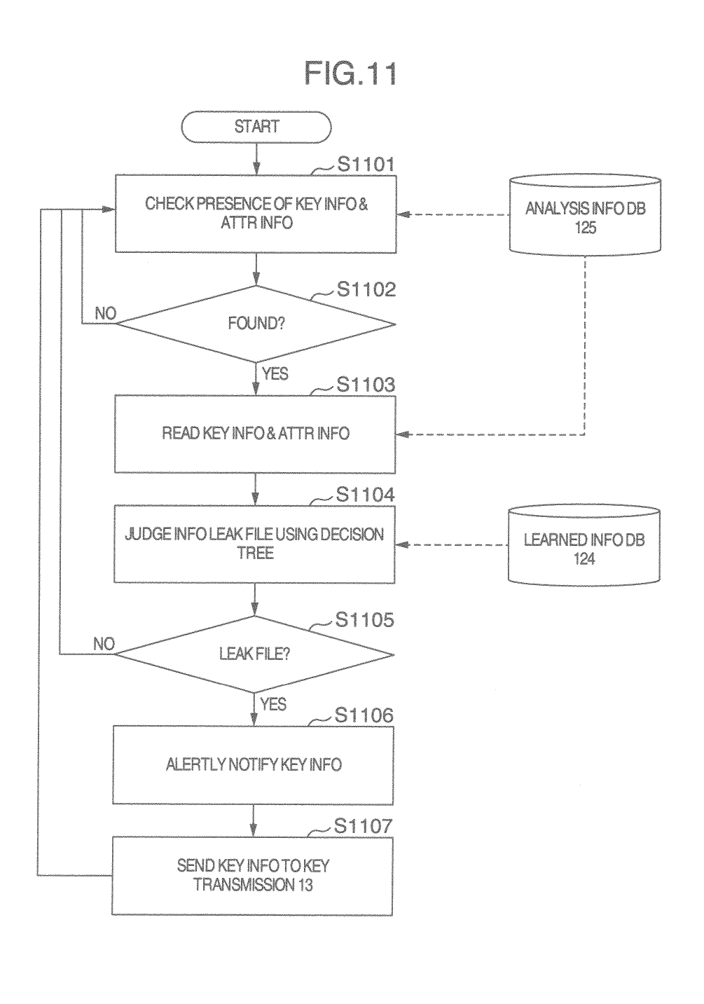

Next, a flow of processing in the key analysis program 123 will be discussed using FIG. 11.

First, the key analysis program 123 issues an inquiry as to whether a pair of key information and attribute information exists in the analysis information DB 125 (at step S1101).

As a result, when any pair of the key information and attribute information is absent, the procedure returns to the step S1101. Alternatively, when the pair of the key information and attribute information is found, the procedure proceeds to the next step (step S1102). More specifically, wait processing is performed until a pair of key information and attribute information is stored in the analysis information DB 125.

If a pair of key information and attribute information is stored in the analysis information DB 125, the pair of the key information and attribute information is read out of the analysis information DB 125 (step S1103).

The pair of the key information and attribute information thus read is inspected using the decision tree 603 stored in the learned information DB 124, thereby determining whether a file corresponding thereto is the information leak file or not (step S1104).

In case it is found by referencing the judgment result that the file being inspected is not the information leak file, the procedure returns to the step S1101. Alternatively, when it is the information leak file, go to the next processing (step S1105).

Then, the key information that was judged to be relevant to the information leak file is notified to the operator as an alert (step S1106). The alert refers to an operation of warning the operator by using on-screen image display or communication means, such as email, instant message, telephone call or wireless call-out (pager) or else, to send information containing therein specified items, such as the file name 12505, file size 12503, key creation time-and-date 12501, key acquisition time-and-date 12502, file possession node information 12506 and download number 12509.

Further, the key information that was judged to be the information leak file is notified to the key transmission device 13 (step S1107). Contents to be sent to the key transmission device 13 include, but not limited to, the file name 12505, hash value 12510, key creation time-and-date 12501, publisher ID (trip) 12503, file possession node information (IP/Port No.) 12506 and key possession node information (IP/Port#) 12507.

Here, a flow of processing in a key transmission program 131 of the key transmitter device 13 will be set forth although it is not depicted.

The key transmission program 131 invalidates the key information based on the key information received from the key analysis program 123 of the information leak file detection device 12 and sends it to one or a plurality of file share nodes 61 being linked to the Internet 50. The operation of invalidating the key information is intended to mean a process of applying special treatment to the key information to thereby make sure that it is no longer possible to download the file, wherein the special treatment includes a step of rewriting the file possession node information (IP address & port No.) 12506 contained in the key information into another node's IP address that is different from the IP address of the inherent node, such as a decoy node, self node (with an IP address of “127.0.0.1”) or the like.

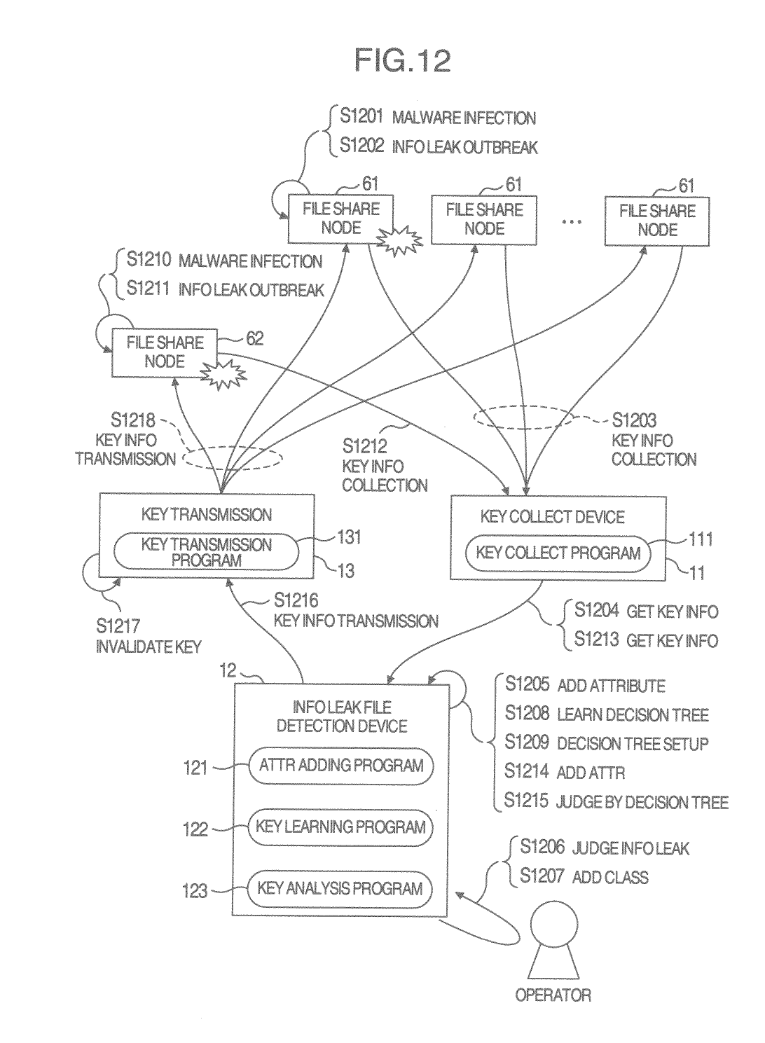

Next, an operation of the information leak file detection system of this embodiment will be described with reference to FIG. 12. FIG. 12 is a diagram showing one example of the operation of the information leak file detection system of this embodiment.

In FIG. 12, an explanation will be given of a case where an information leakage incident occurred due to the fact that a plurality of file share nodes 61 and 62 being presently linked to the Internet 50 (see FIG. 1) are infected with a malware. Note that in FIG. 12, a key collection device 11, information leak file detection device 12 and key transmission device 13 are the same as those shown in FIG. 1; so, an explanation thereof is eliminated herein.

First of all, one of the file share nodes 61 is infected with the malware (at step S1201). Next, at such file share node 61, either private information or confidential corporate information is set by the bad-behaving malware to being made available for upload to file-sharing software, resulting in the outbreak of an information leakage incident (step S1202).

The key information concerning the file(s) released by such information leakage incident is collected, together with key information as to normal files, by a key collection program 111 of the key collection device 11 (step S1203).

The information leak file detection device 12 acquires key information from the key collection device 11 by means of the attribute addition program 121 (step S1204), and derives and adds a relevant attribute with respect to each of key information included in the acquired key information (step S1205). The operator reviews the information (key information and attribute information) concerning the key information obtained during execution of the processing up to the step S1205 and judges therefrom whether each key information is relevant to the information leak file (step S1206), causing a judgment result to be added as a class (step S1207). The resultant key information, attribute information and class which are obtained by these processing operations are collectively referred to as the supervised information 601. A prespecified number of supervised information collected are input to the decision tree learning algorithm 602 of the key learning program 122, thereby forcing it to perform decision-tree learning (step S1208). A judgment-use decision tree 603 of the information leak file which was obtained by such decision-tree learning session is set to being used for the key analysis program 123 (step S1209).

Assume here that the file share nodes 62 is newly malware-infected (at step S1210). Next, at such file share nodes 62, either personal information or confidential information is set by the bad-behaving malware to being made available for upload to the file sharing software, resulting in the outbreak of an information leakage incident (step S1211).

The key information concerning the file released by such new information leak incident is collected, together with key information as to normal files, by the key collection program 111 of the key collection device 11 (step S1212).

The information leak file detection device 12 acquires key information from the key collection device 11 by means of the attribute addition program 121 (step S1213), and derives for addition a relevant attribute with respect to each of key information contained in such key information (step S1214). Further, the key analysis program 123 operates in accordance with the decision tree 603 that was set at step S1209 to perform decision-tree judgment with respect to the key information acquired from the file share nodes 62 (step S1215). Then, from the judgment result specifying that it is relevant to the information leak file, information as to this key information (here, the file name 12505, file size 12503 and hash value 12510) are transmitted to the key transmission program 131 of the key transmitter device 13 (step S1216).

In response to receipt of the information concerning the key information from the information leak file detection device 12, the key transmission program 131 of key transmitter device 13 sets the possession node information (IP address & port No.) 12506 to IP address=“127.0.0.1” and port number=10000 while letting the file name 12505, file size 12503 and hash value 12510 be kept unchanged, thereby invalidating the key information (step S1217). Next, the invalidated key information is sent to multiple nodes, such as the file share nodes 61 and 62 (step S1218).

By the above-stated processing, the file share nodes 61-62 are caused to have and hold the invalidated key information. As a result, even when an unauthorized attempt is made to use this key information to download the file that have been accidentally leaked by the file share node 62, the attempt ends up with establishment of a mere download connection to a node with the IP address-127.0.0.1 and port number=10000 as recited in the possession node information (IP Addr & Port#) of the already invalidated key information, thereby making download inexecutable.

The specification and drawings are, accordingly, to be regarded in an illustrative rather than a restrictive sense. It will, however, be evident that various modifications and changes may be made thereto without departing from the spirit and scope of the invention(s) as set forth in the claims.

We claim:

1. An information leak file detection apparatus communicably coupled to a key information collection device linking to a file sharing network and having a key information database storing therein key information collected in relation to files distributed on the file sharing network, wherein the apparatus operates to:
acquire from the key information database the key information including a key creation time-and-date, a key acquisition time-and-date, a file size, a publisher ID (trip), a file name, file possession node information (IP address, port number), key possession node information (IP address, port number), a key lifetime (TTL), a download number (referenced number) and a hash value,
obtain as attribute information a file type to be derived from the file name contained in the key information, an appearance number of each speech part of those words constituting the file name, a difference between the key creation time-and-date and a key acquisition time-and-date relating to the file, and presence or absence of a character string indicative of time-and-date, and then store the key information and the attribute information in an analysis information database,
make a decision tree which is an information leak file judgment rule based on contents of the key information and the attribute information, and then store the decision tree in a leaned information database, and
determine whether an acquisition source file of the key information is an information leak file based on the key information and the attribute information which are stored in the analysis information database and also based on the decision tree stored in the learned information database.

2. The information leak file detection apparatus according to claim 1, wherein the apparatus acquires supervised information (attribute) from the attribute information by letting the key information within the analysis information database be supervised information (key information),
receives as supervised information (class) a result of operator's decision as to whether it is a leak file based on the supervised information (key information) and the supervised information (attribute),
stores the supervised information (key information), the supervised information (attribute) and the supervised information (class) in the learned information database while combining them into a set, and
makes the decision tree based on supervised information containing therein a plurality of sets of the supervised information (key information), the supervised information (attribute) and the supervised information (class) of the learned information database.

3. The information leak file detection apparatus according to claim 1, wherein the apparatus modifies the information leak file judgment rule in a way corresponding to the decision tree which is generated and updated based on supervised information as newly created by an arithmetic device.

4. The information leak file detection apparatus according to claim 1, wherein the apparatus outputs to a key transmission device the key information concerning the file in accordance with a result of judgment of an arithmetic device concluding that the file is an information leak file by comparison with the decision tree.

5. The information leak file detection apparatus according to claim 1, wherein the apparatus is communicably coupled to a key transmission device which sends out any given one of the key information toward a given node being linked to the file sharing network, which collects information concerning a shared file or files from the file sharing network and which enables outputting of the key information, and
transmits the key information concerning the file to the key transmission device in accordance with a result of judgment concluding that the file is the information leak file by comparison with the decision tree.

6. An information leak file detection method for use in an information leak file detection apparatus for collecting information concerning files distributed on a file sharing network and for preventing spread of an information leak file, wherein
the information leak file detection apparatus has an arithmetic unit and a database,
the database stores therein an information leak file judgment rule as a decision tree based on contents of key information and attribute information by using, as the key information, information including any one or more than one of those items obtainable from a key collection device, which are a key creation time-and-date, a key acquisition time-and-date, a file size, a publisher ID (trip), a file name, file possession node information (IP address, port number), key possession node information (IP address, port number), a key lifetime (TTL), a download number (referenced number) and a hash value, and also by using as the attribute information a file type to be derived from an extension of the file name contained in the key information, an appearance number of each speech part of those words making up the file name, a difference between the key creation time and a key acquisition time relating to the file, and presence or absence of a character string indicating time-and-date be the attribute information, and
the arithmetic unit compares the key information and the attribute information with the decision tree to thereby determine whether the key information is relevant to an information leak file.

7. The information leak file detection method according to claim 6, wherein the method is an information leak file detection method used in an information leak file detection apparatus for collecting information concerning shared files from a file sharing network and for preventing spread of an information leak file, wherein
the information leak file detection apparatus has an arithmetic unit and a database,
the database stores therein respective ones of supervised information (key information), supervised information (attribute) and supervised information (class) which are obtained by extracting a predetermined number of ones by letting the key information be the supervised information (key information) and by letting attribute information be the supervised information (attribute) and further by setting as the supervised information (class) a result of operator's judgment as to whether it is the leak file based on the supervised information (key information) and the supervised information (attribute), and
the arithmetic unit generates a decision tree for judgment of the information leak file by inputting, to a decision tree learning algorithm, supervised information which is obtained by creating a plurality of sets of the supervised information (key information), the supervised information (attribute) and the supervised information (class).

8. The information leak file detection method according to claim 6, further including:
modifying an information leak file judgment algorithm in accordance with generation and update of the decision tree.

9. The information leak file detection method according to claim 6, further including:
outputting to a key transmission device the key information concerning the file in response to a result of judgment concluding to be the information leak file by comparison with the decision tree.

10. The information leak file detection method according to claim 6, wherein the method is an information leak file detection method used in an information leak file detection apparatus for collecting information concerning a shared file or files from the file sharing network, for making it possible to output key information and for being communicably coupled with a key transmission device which sends any given key information to a given node for connection to the file sharing network, wherein the method includes:
transmitting the key information concerning the file to the key transmission device in accordance with a result of judgment concluding to be the information leak file by comparison with the decision tree.

11. A computer-readable file detection program comprising the steps of:
linking to a file sharing network;
being communicably coupled to a key information collection device having a key information database storing therein key information collected relating to files distributed on the file sharing network;
acquiring from the key information database the key information including a key creation time-and-date, a key acquisition time-and-date, a file size, a publisher ID (trip), a file name, file possession node information (IP address, port number), key possession node information (IP address, port number), a key lifetime (TTL), a download number (referenced number), and a hash value;
obtaining as attribute information a type of file to be derived from the file name included in the key information, an appearance number of each speech part of those words making up the file name, a difference between the key creation time-and-date and a key acquisition time-and-date relating to the file, and presence or absence of a character string indicating time-and-date, and storing the key information and the attribute information in an analysis information database;
making a decision tree which is an information leak file judgment rule based on contents of the key information and the attribute information and then storing the decision tree in a learned information database; and
determining whether an acquisition source file of the key information is an information leak file based on the key information and the attribute information which are stored in the analysis information database and also based on the decision tree stored in the learned information database.
